(19) United States
(12) Patent Application Publication
(10) Pub. No.: US 2009/0227345 A1
(43) Pub. Date: Sep. 10, 2009

(54) Gaming Machine Having a Secondary Game with a Restricted Display Area

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/390,018

(22) Filed: Feb. 20, 2009

Related U.S. Application Data
(60) Provisional application No. 61/035,130, filed on Mar. 10, 2008.

(51) Int. Cl. A63F 13/00

(52) U.S. Cl. 463/20

(57) ABSTRACT

A gaming machine 10 is provided with a liquid crystal display 30 including a symbol display area divided into a plurality of symbol display regions 301 to 315 for displaying a plurality of kinds of symbols dynamically and statically for each game. The gaming machine 10 has a mode for performing a first game in which an award is determined based on a number of identical symbols statically displayed within the symbol display area including all the symbol display regions 301 to 315, and in addition, has a mode for performing a second game in which a portion of the symbol display area is set as an active symbol display area ASA1. The second game, which is performed with a reduced display area compared to that of the first game, provides a player with an advantageous condition.

### CROSS REFERENCE TO RELATED APPLICATIONS

This application claims priority to U.S. Provisional Application Ser. No. 61/035,130, filed on Mar. 10, 2008, which is incorporated herein by reference.

### BACKGROUND OF THE INVENTION

1. Field of the Invention

The present invention relates to a gaming machine which provides a slot game in which a plurality of symbols are dynamically and statically displayed, and performs a bonus game corresponding to a predetermined combination of symbols.

2. Related Art

It is known that conventional slot machines start a game when a predetermined amount of credit is bet, then start to scroll a plurality of reels on which a plurality of symbols is depicted, and stop the scrolling after the predetermined period of time elapses. As a result, a certain award is provided to a player based on a stationary combination of symbols.

U.S. Pat. No. 6,224,483 discloses a slot machine which performs a main game of reel slot having at least five pay lines (activated lines) with five reels and a second event game with a rotatable wheel used for a bonus game. In this slot machine, when a predetermined combination of symbols for providing a bonus game is achieved in a reel slot game, a rotatable wheel bonus game that is a secondary event is performed based on the number of pay lines on which the symbol combinations are achieved and a credit amount bet for each pay line.

Furthermore, in regard to the abovementioned slot machine, a player consistently expects a predetermined combination of symbols to be achieved on a pay line (activated line) which triggers starting of a bonus game. In other words, since a bonus game is not performed unless the predetermined combination of symbols is achieved on activated lines of five reels, the slot machine has a shortcoming that it lacks in entertainment properties.

### SUMMARY OF THE INVENTION

An object of the present invention is to provide a gaming machine which does not perform a game in which symbols are displayed dynamically and then statically only on all symbol display regions, such as any types of reels (including video reels) throughout the game, but a gaming machine which performs a game that may advance to a special game performed with a display area reduced in size. With such a configuration, a player can advance a game with an advantageous condition and with greater excitement.

Furthermore, an object of the present invention is to provide a gaming machine which can further improve entertainment properties.

In an aspect of the present invention, a gaming machine includes:

a display, having a symbol display area divided into a plurality of symbol display regions, for displaying a plurality of kinds of symbols to be displayed dynamically and statically in each of the symbol display regions for each game,

an input device for starting a game in which a predetermined award is provided based on a number of identical symbols statically displayed in the plurality of symbol display regions within the symbol display area, and

a controller configured to execute the processing including:

(a) performing a first game in which an award is determined based on a number of identical symbols statically displayed within the symbol display area including all the symbol display regions, and

(b) performing a second game in which a portion of the symbol display area is set as an active symbol display area, and an award is determined based on a number of identical symbols statically displayed for each unit game in which a plurality of kinds of symbols is dynamically and statically displayed in the active symbol display area.

According to the present invention, a player starts the first game expecting more identical symbols to be displayed in the symbol display area including all the symbol display regions, and furthermore, has another expectation for the second game in which symbols are displayed in the active symbol display area which includes only a portion of the symbol display regions instead of all the symbol display regions. In other words, in the second game, a display area is reduced in size compared to that of the symbol display area used in the first game, so that the player can obtain more advantageous condition. With such a configuration, the present invention can provide a gaming machine with a high entertainment property that allows a player to enjoy a game having a restricted game area of a slot game display area.

In another aspect of the present invention, a gaming machine includes a controller configured to execute the processing including:

(a) performing a first game in which an award is determined based on a number of identical symbols statically displayed within the symbol display area including all the symbol display regions, and (b) in a case where a symbol statically displayed in a specified symbol display region within the symbol display area matches a wild symbol substitutable for any kind of symbol, performing a second game in which the symbol display regions surrounding the wild symbol as a center and immediately adjacent to the wild symbol are set as an active symbol display area, and an award is determined based on a number of identical symbols statically displayed for each game in which a plurality of kinds of symbols is dynamically and statically displayed in the active symbol display area.

In still another aspect of the present invention, a gaming machine includes a controller configured to execute the processing including:

(a) performing a first game in which an award is determined based on a number of identical symbols statically displayed within the symbol display area including all the symbol display regions, and

(b) in a case where a symbol that is statically displayed in a specified symbol display region prior to other symbols to be displayed in any other symbol display region during the first game matches a wild symbol substitutable for any kind of symbol, performing a second game in which the symbol display regions surrounding the wild symbol as a center and immediately adjacent to the wild symbol are set as an active symbol display area, and an award is determined based on a number of identical symbols statically displayed for each game in which a plurality of kinds of symbols is dynamically and statically displayed in the active symbol display area.

Each of the second and the third aspects of the present invention described above clarifies a mode in which a wild symbol is used as a trigger to start a second game. Such a configuration enables a gaming machine with a high entertainment property that allows a player to enjoy a game having a restricted game area of a slot game display area.

### BRIEF DESCRIPTION OF THE DRAWINGS

FIG. 1 is an example of a display screen of a game performed by a gaming machine according to an embodiment of the present invention;

FIG. 2 is a perspective view showing an appearance of the gaming machine according to the embodiment of the present invention;

FIG. 3 is a plan view showing an enlarged display area of the gaming machine according to the embodiment of the present invention;

FIG. 4 is a block diagram of a controller of the gaming machine according to the embodiment of the present invention;

FIG. 5 is a block diagram of a display/input controller of the gaming machine according to the embodiment;

FIG. 6 is a flow chart showing processing of mainly a first game (a basic game) of the gaming machine according to the embodiment of the present invention;

FIGS. 7 to 9 are flow charts showing an example of a portion of processing in FIG. 6;

FIG. 10 is a diagram showing a stationary symbol probability table for identical symbols according to the embodiment of the present invention;

FIG. 11 is a diagram showing a stationary symbol probability table for a wild symbol according to the embodiment of the present invention;

FIGS. 12 to 19 are examples of display screens of rendered images displayed by the gaming machine according to the embodiment of the present invention; and

FIG. 20 is a flow chart showing an example of a modification of FIG. 7 according to one embodiment of the present invention.

### DETAILED DESCRIPTION OF THE INVENTION

A gaming machine according to the present invention is hereinafter described in detail with reference to the attached drawings. The present embodiments may preferably be applied to a gaming machine such as a slot game. An example of such a gaming machine includes a gaming machine that has an image displaying device such as a liquid crystal display, and which advances a game by displaying images of various kinds of symbols on the image displaying device.

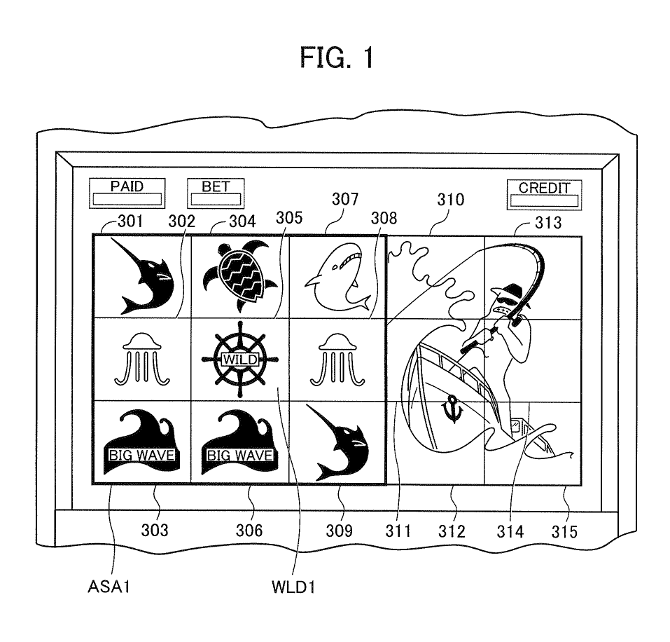

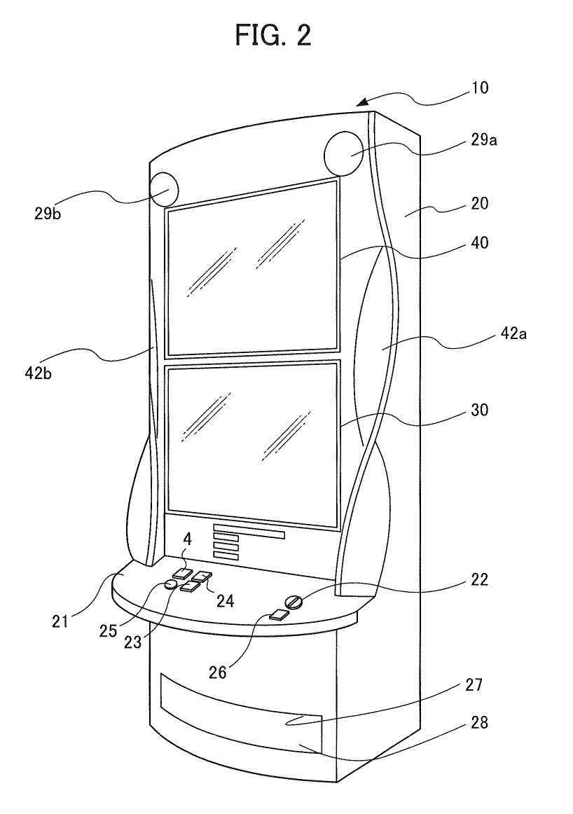

FIG. 1 is an example of a display screen of a game performed by the gaming machine according to an embodiment of the present invention. FIG. 2 is a perspective view showing an appearance of the gaming machine according to an embodiment of the present invention.

A gaming machine 10 includes an image display device such as a liquid crystal display 30, and advances the game by displaying various kinds of symbol images on the image display device. The liquid crystal display 30 includes a symbol display area divided into a plurality of symbol display regions 301 to 315 for dynamically and statically displaying a plurality of kinds of symbols in each of the symbol display regions 301 to 315 for each game. A start switch 25, which is one of input devices, is provided on an operation unit 21 placed below the liquid crystal display 30. A game starts upon a pushing operation of the start switch 25. In the game, a predetermined award is provided based on a number of identical symbols (symbols of the same kind) statically displayed in each of the symbol display regions 301 to 315.

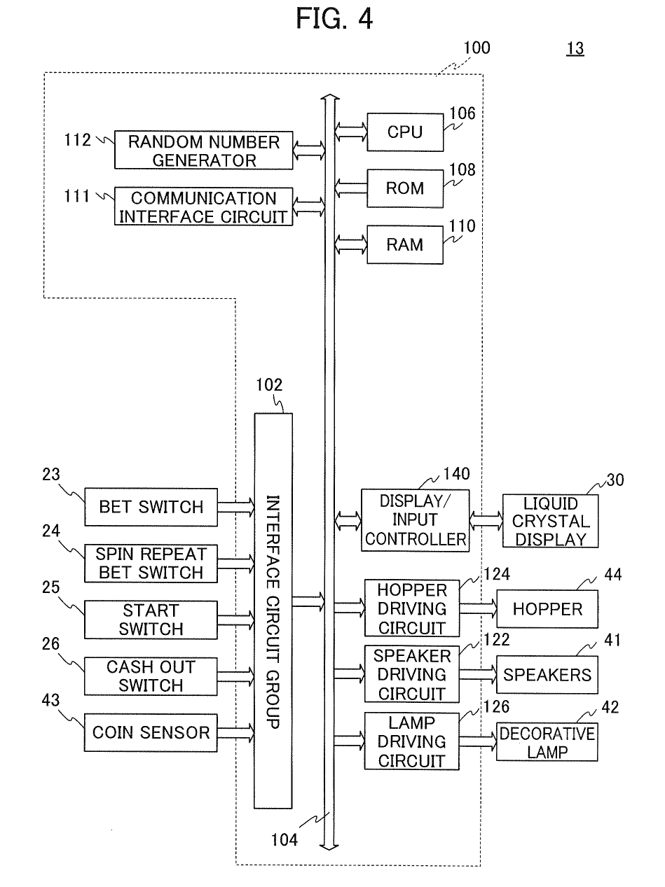

The gaming machine 10 at least includes a controller (for example, a CPU 106 in FIG. 4, which is described later) for executing the processing including:

(a) performing a first game in which an award is determined based on a number of identical symbols statically displayed within the symbol display area including all the symbol display regions 301 to 315, and (b) performing a second game in which a portion of the symbol display area including all the symbol display regions 301 to 315 is set as an activated symbol display area ASA1. In the second game processing, an award is determined based on the number of identical symbols statically displayed for each unit game in which a plurality of kinds of symbols are dynamically and statically displayed within the active symbol display area ASA1.

More preferably but not necessarily, the first game is performed as a basic game. In the basic game, a plurality of kinds of symbols are dynamically displayed in each of the symbol display regions 301 to 315, and when a symbol is statically displayed, an award is determined based on the number of identical symbols. At this stage, as shown in FIG. 1, in a case where a stationary symbol displayed in a specified symbol display region (305 in FIG. 1) matches a wild symbol WLD1 substitutable for any kind of symbol, the symbol display regions surrounding the wild symbol as a center and immediately adjacent to the wild symbol WLD1 are set as an active symbol display area ASA1. A second game in which a plurality of kinds of symbols are dynamically and statically displayed within the active symbol display area ASA1 is performed as a bonus game, and an award is determined based on the number of identical symbols statically displayed for each unit game.

In an example of FIG. 1, the wild symbol WLD1 positioned at the center of the active symbol display area ASA1 is fixed as a stationary symbol from a beginning of the second game (a bonus game) during a single game or a plurality of games. In a case where a plurality of kinds of symbols are dynamically displayed in the symbol display regions 301 to 304 and 306 to 309 which are adjacent to the wild symbol WLD1 and identical symbols are afterward statically displayed on any one of vertical, horizontal and diagonal lines, including the wild symbol WLD1 at the center, it indicates that an active line is formed. An award is determined according to a combination of symbols displayed on the active line. Furthermore, in the second game, symbol display regions other than those lying within the active symbol display area ASA1, that is, symbol display regions 310 to 315, are utilized as a display area for displaying a rendered image, information, guide and the like.

The gaming machine 10 shown in FIG. 2 is described in detail. The gaming machine 10 includes a cabinet 20. The cabinet 20 has a structure in which the face facing the player is open. The cabinet 20 contains various components including a game controller 100 (refer to FIG. 4) for electrically controlling the gaming machine 10 and a hopper 44 (refer to FIG. 4) for controlling the insertion, storage, and payout of coins (game media), and the like. The game medium is not restricted to coins. In addition, examples of such game media include medals, tokens, electronic money, or electronic value information (credit) having the same value.

The liquid crystal display 30 is provided substantially at the center on a front surface of the cabinet 20. The liquid crystal display 30 realizes a display device for displaying various kinds of images related to a game including rendered images and the like. Such a configuration allows the player to advance the game while visually confirming various kinds of images displayed on the liquid crystal display 30. Examples of such a game include slot games shown in FIG. 1 and FIGS. 12 to 19 which are described later.

The liquid crystal display 30 of the gaming machine 10 includes a symbol display area divided into a plurality of symbol display regions (301 to 315). The symbol display regions are configured with video reels for displaying a plurality of virtual reels, for example. It should be noted that the term “video reel” as used here represents a mechanism for displaying a reel on the liquid crystal display 30 in a form of an image instead of mechanical reel. In the present embodiment, fifteen video reels are displayed on the liquid crystal display 30. In other words, the symbol display area is provided, which is divided into fifteen symbol display regions (301 to 315).

Another liquid crystal display 40 may be further provided above the liquid crystal display 30. The liquid crystal display 40 can be utilized as a sub display for displaying game rules, a demonstration screen and the like. Sound transmitting openings 29a and 29b, which are provided near the upper portion of the cabinet 20, transmit sound effects, generated by speakers 41 (refer to FIG. 4) contained in the cabinet 20, to the outside of the cabinet 20. The sound transmission openings 29a and 29b generate sound effects and the like in accordance with the progress of the game. Decorative lamps 42a and 42b are disposed on both the right and left sides of the substantially center of the gaming machine 10 and emit light in accordance with the progress of the game.

A substantially horizontal operation unit 21 is provided below the liquid crystal display 30. On the operation unit 21, a coin insertion slot 22, a bet switch 23, a spin repeat bet switch 24 and a start switch 25 are provided. The bet switch 23 selects an amount of coins to be bet for a game among a plurality of coins inserted from the coin insertion slot 22. The spin repeat bet switch 24 starts a game without changing the amount of coins to be bet from the amount of coins bet in a previous game. Such arrangements allow a player to set the amount of coins to be bet for a group of symbols to be formed on activated lines in response to a pushing operation of the bet switch 23 or the spin repeat bet switch 24. The start switch 25 accepts a starting operation of a game by a player for each game. Upon performing a pressing operation on either the start switch 25 or the spin repeat bet switch 24, which serves as a trigger to start the game, the plurality of symbol display regions starts to display symbols dynamically.

A cash out switch 26 is provided near the coin insertion slot 22 on the operation unit 21. Upon a pushing operation on the cash out switch 26 by a player, inserted coins are paid out from a coin payout opening 27 provided at a lower portion of a front face of the cabinet 20. The coins thus paid out are retained in a coin tray 28.

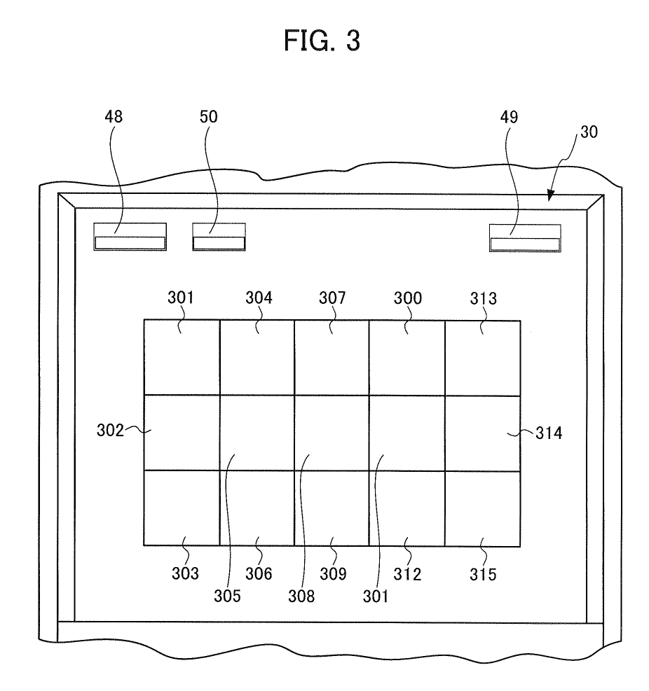

FIG. 3 is an enlarged display area of the liquid crystal display 30 of the gaming machine 10. The same components as those shown in FIG. 1 are denoted by the same reference numerals. A symbol display area including the symbol display regions 301 to 315 is divided into a matrix of three rows and five columns, which are also referred to as symbol display blocks or symbol display positions. Fifteen video reels are provided to the symbol display regions 301 to 315, respectively.

A payout amount display unit 48, a bet amount display unit 50, and a credit amount display unit 49 are displayed in this order from the left side on the upper portion of the liquid crystal display 30. The payout amount display unit 48 displays the payout amount of coins, when at least a predetermined number of identical symbols for providing an award is statically displayed in the symbol display regions 301 to 315. The credit amount display unit 49 displays the credit amount of coins stored in the gaming machine 10. The bet amount display unit 50 displays a bet number, which is the amount of coins being bet.

FIG. 4 is a block diagram showing the electrical configuration of the game controller 100 of the gaming machine 10. The controller 100 of the gaming machine 10 is a microcomputer, and includes an interface circuit group 102, a CPU 106, ROM 108, RAM 110, a communication interface circuit 111, a random number generator 112, a speaker driving circuit 122, a hopper driving circuit 124, a lamp driving circuit 126, and a display/input controller 140. These components mentioned above are connected with an input/output bus 104.

The input/output bus 104 transmits the input/output of data signals or address signals to and from the CPU 106. The start switch 25 is electrically connected with the interface circuit group 102. A start signal generated by the start switch 25 is converted into a predetermined form of signal in the interface circuit group 102 to be supplied to the input/output bus 104.

The bet switch 23, the spin repeat bet switch 24, and the cash out switch 26 are also connected with the interface circuit group 102. Each of the switching signals output from these switches 23, 24, and 26 is also supplied to the interface circuit group 102, and is converted into a predetermined form of signal by the interface circuit group 102 to be supplied to the input/output bus 104.

A coin sensor 43 is also electrically connected with the interface circuit group 102. The coin sensor 43 detects coins inserted into the coin insertion slot 22 and is disposed at an appropriate position relative to the coin insertion slot 22. The sensing signal output from the coin sensor 43 is also supplied to the interface circuit group 102, and is converted into a predetermined form of signal by the interface circuit group 102, to be supplied to the input/output bus 104.

Upon acceptance of a start operation of a game via the start switch 25, the CPU 106 reads a game program and performs the game. The game program is programmed so as to instruct the CPU 106 to start dynamically displaying symbols depicted on video reels in each of the symbol display regions 301 to 315 on the liquid crystal display 30 via the display/input controller 140, and subsequently displays those symbols statically. Consequently, in a case where the number of identical symbols arranged among all the stationary symbols is equal to or greater than a predetermined number, the CPU 106 pays out coins based on the number of the identical symbols.

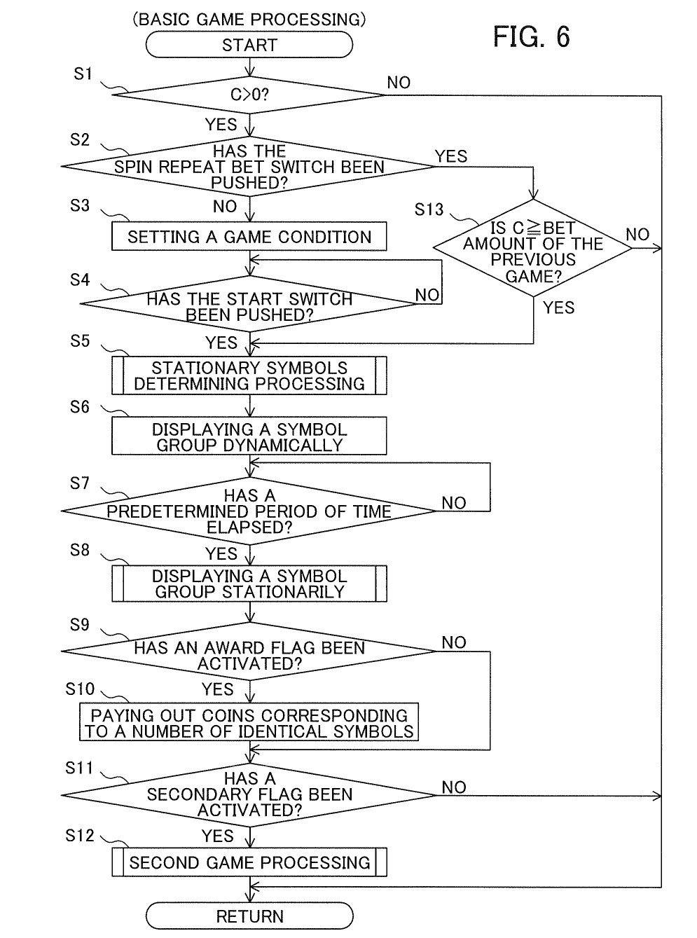

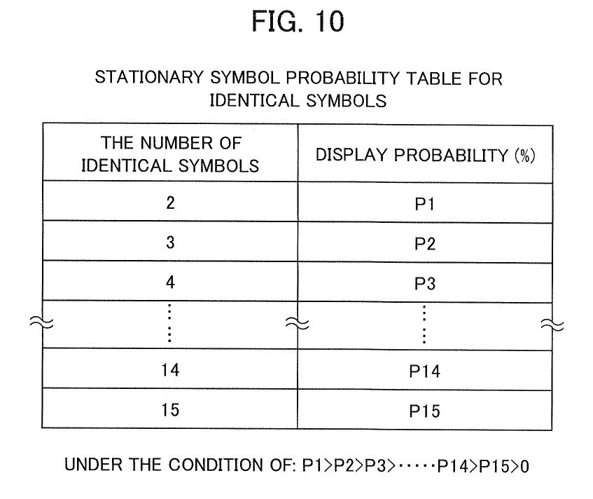

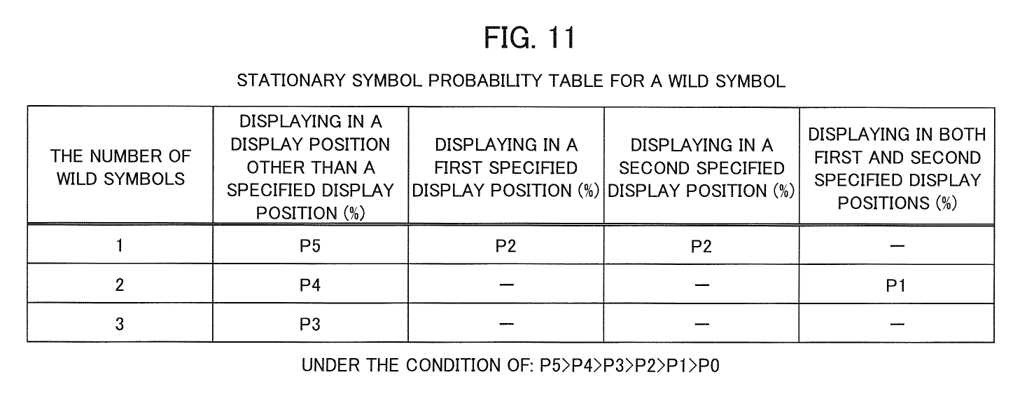

The ROM 108 stores a control program for centrally controlling the gaming machine 10, a program for executing routines shown in FIGS. 6 to 8 (hereinafter referred to as a “routine program”), initial data for executing the control program, and various data tables used for determining processing. The routine program includes the abovementioned game program. The data tables shown in FIGS. 10 and 11 are examples of data tables. The RAM 110 temporarily stores flags, variables, and the like used for the control program.

The game program includes a program for determining a stationary symbol. The stationary symbol determining program is a program for determining fifteen symbols to be statically displayed on the symbol display regions 301 to 315. The stationary symbol determining program includes symbol weighing data that corresponds to each of a plurality of kinds of payout ratios (e.g., 80%, 84%, and 88%). The symbol weighing data is data for each of the fifteen video reels, which indicates the correspondence between each symbol and one or a plurality of random numbers in a predetermined number range (0 to 256). The payout ratio is determined based upon the payout ratio setting data stored in the ROM 108. The stationary symbol is determined based upon the symbol weighing data that corresponds to the payout ratio.

The communication interface circuit 111 communicates with a server and a central controller via various kinds of communication networks, such as a LAN.

A random number generator 112 generates random numbers lying in a predetermined range of “0” to “65535” (two to the sixteenth power minus one), for example. Alternatively, the CPU 106 may generate a random number by computation.

The speaker driving circuit 122 drives the speakers 41. The CPU 106 reads sound data stored in the ROM 108 and transmits the sound data thus read to the speaker driving circuit 122 via the input/output bus 104. In this way, the speakers 41 generate predetermined sound effects.

The hopper driving circuit 124 drives the hopper 44. The CPU 106 outputs a driving signal to the hopper driving circuit 124 via the input/output bus 104 in response to receiving a cash out signal from the cash out switch 26. Accordingly, the hopper 44 pays out an amount of coins equivalent to the current amount of remaining credits, which is stored in a predetermined memory area of the RAM 110.

Alternatively, payout of coins may be performed in a mode of storing credit data in a data card or the like, instead of using physical coins. In other words, the player may carry a card which serves as a recording medium, and store the data related to the credit by inserting the card into the gaming machine 10.

The lamp driving circuit 126 drives the decorative lamps 42a and 42b. The CPU 106 transmits the signal for driving the lamps according to predetermined conditions based on the program stored in the ROM 108 to the lamp driving circuit 126. Thus, the decorative lamps 42a and 42b blink and the like.

The display/input controller 140 generates a signal for driving the liquid crystal displays 30 and 40 according to an image display instruction. The CPU 106 generates an image display instruction according to the status and outcome of the game, and outputs the image display instruction thus generated to the display/input controller 140 via the input/output bus 104. Upon reception of the image display instruction from the CPU 106, the display/input controller 140 generates a driving signal for driving the liquid crystal displays 30 and 40 according to the image display instruction thus input, and outputs the driving signal thus generated to the liquid crystal displays 30 and 40. Consequently, a predetermined image is displayed on the liquid crystal displays 30 and 40. The display/input controller 140 transmits the signal input via the touch panel 32 provided on the liquid crystal display 30 to the CPU 106 via the input/output bus 104 in the form of an input signal. In addition, the image display instruction includes instructions for a payout display unit 48, a credit amount display unit 49, and a bet amount display unit 50.

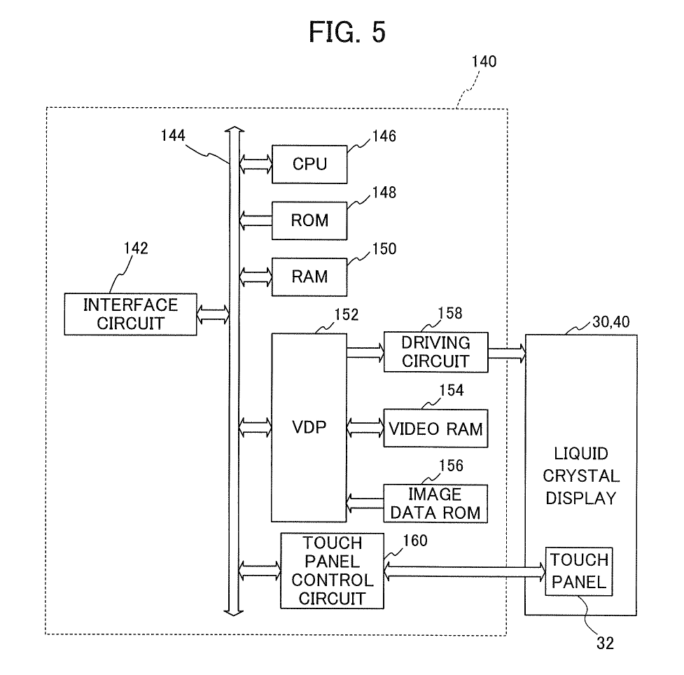

FIG. 5 is a block diagram showing the electrical configuration of the display/input controller 140 of the gaming machine 10. The display/input controller 140 of the gaming machine 10 is a sub-microcomputer which executes an image display processing and controls input from the touch panel 32. The display/input controller 140 includes an interface circuit 142, a CPU 146, ROM 148, RAM 150, a VDP 152, video RAM 154, ROM 156 for storing image data, a driving circuit 158, and a touch panel controlling circuit 160. These components are connected with input/output bus 144.

An image display instruction output from the CPU 106 of the game controller 100 is supplied to the input/output bus 144 via the interface circuit 142. The input/output bus 144 inputs and outputs data signals and addresses signals to/from the CPU 146.

The ROM 148 stores a display control program for generating a driving signal to be supplied to the liquid crystal displays 30 and 40 according to the image display instruction from the CPU 106 of the game controller 100. The RAM 150 stores flags and variables used for the display control program.

The VDP 152 includes a so-called sprite circuit, a screen circuit, a palette circuit, and the like, and performs various kinds of processing for displaying images on the liquid crystal displays 30 and 40. The video RAM 154 and the image data ROM 156 are connected to the VDP 152. The video RAM 154 stores image data based on the image display instructions from the CPU 106 of the game controller 100. The image data ROM 156 stores various kinds of image data including the abovementioned rendered image data. The driving circuit 158 for outputting a driving signal to drive the liquid crystal displays 30 and 40 is connected to the VDP 152.

The CPU 104 reads and executes the display control program stored in the ROM 148, and instructs the video RAM 154 to store image data to be displayed on the liquid crystal displays 30 and 40 according to the image display instruction from the CPU 106 of the game controller 100. The image display instruction includes various kinds of instructions including an instruction for displaying the abovementioned rendered image and the like.

The image data ROM 156 stores various kinds of image data including the image data for the rendered image and the like. The touch panel control circuit 160 transmits a received input signal via the touch panel 32 provided on the liquid crystal display 30 to the CPU 106 via the input/output bus 144 in the form of an input signal.

FIG. 6 is a flow chart showing a flow of processing operation mainly for a first game of the gaming machine 10, which is executed by the game controller 100 of the gaming machine 10. One round of routine shown in FIG. 6 performed by the game controller 100 produces a unit game. The first game is a basic game, for example. A description is provided with reference to FIGS. 3 to 5.

It is supposed that the gaming machine 10 is activated in advance, and that the variables used in the CPU 106 of the controller 100 are initialized to predetermined values, whereby the gaming machine 10 is operating in a normal state.

Firstly, the CPU 106 of the game controller 100 determines whether there remains a certain amount of credit which is equivalent to a remaining amount of coins a player inserted (Step S1). More specifically, the CPU 106 reads a credit amount C stored in the RAM 110, and executes processing based on the credit amount C thus read. In a case where the credit amount C is “0” (“NO” in Step S1), the CPU 106 terminates the routine without any processing since a game is not permitted to start. On the other hand, in a case where the credit amount C is at least “1” (“YES” in Step S1), the CPU 106 determines that there are credits remaining, and advances the processing to Step S2.

In Step S2, the CPU 106 determines whether or not a pushing operation has been executed on the spin repeat bet switch 24. When the spin repeat bet switch 24 has been pushed, and accordingly, an operation signal from the spin repeat switch 24 has been input to the CPU 106 (“YES” in Step S2), the CPU 106 advances the process to Step S13. On the other hand, in a case where the CPU 106 receives no operation signal from the spin repeat bet switch 24 during a predetermined period of time (“NO” in Step S2), the CPU 106 determines that the spin repeat bet switch 24 has not been pushed, and advances the processing to Step S3.

In Step S3, the CPU 106 sets game conditions. More specifically, the CPU 106 determines the amount of coins to be bet for a unit game based on the operation of the bet switch 23. Here, the CPU 106 receives an operation signal output in response to the operation of the bet switch 23, and based on the number of times the CPU 106 has received the signal, the CPU 106 stores the bet amount in a predetermined memory area of the RAM 110. The CPU 106 reads a credit amount C stored in a predetermined area of the RAM 110, subtracts the abovementioned bet amount from the credit amount C thus read, and stores the subtracted value in a predetermined memory area of the RAM 110. Subsequently, the CPU 106 advances the processing to Step S4.

In the Step S4, the CPU 106 determines whether or not the start switch 25 has been activated, and stands by until the start switch 25 is operated. Upon the start switch 25 being operated, and accordingly, upon an operation signal being received from the start switch 25 (“YES” in Step S4), the CPU 106 determines that the start switch 25 has been operated, and advances the processing to Step S5.

On the other hand, in Step S13, the CPU 106 determines whether or not the credit amount C is at least the bet amount in a previous game. In other words, the CPU 106 determines whether or not the CPU 106 can start a game in response to a pushing operation performed on the spin repeat bet switch 24. More specifically, when the spin repeat bet switch 24 has been pushed and the CPU 106 receives the operation signal via the spin repeat bet switch 24, the CPU 106 reads the credit amount C and the credit amount bet in the previous game stored in the RAM 110. Then, the CPU 106 executes processing according to the determination on whether the credit amount C is at least the total credit amount bet in the previous game. In a case where the CPU 106 determines that the credit amount C is less than the bet amount in the previous game (“NO” in Step S13), the CPU 106 terminates the routine without executing any processing, since the game cannot be started. On the other hand, in a case where the CPU 106 determines that the credit amount C is at least the bet amount in the previous game (“YES” in Step S13), the CPU 106 subtracts the bet amount in the previous game from the credit amount C, and stores the subtracted value in a predetermined area of the RAM 110. Subsequently, the CPU 106 advances the processing to Step S5.

In Step S5, the CPU 106 executes processing for determining a stationary symbol. The specific details of the processing for determining a stationary symbol are described below.

Firstly, the CPU 106 extracts a random number from the random number generator 112 and selects a random number corresponding to each of the fifteen video reels from a random number range of 0 to 255. Then, the CPU 106 reads payout rate setting data from the ROM 108 and stores the data in the RAM 110, refers to the symbol weighing data corresponding to the payout rate setting data, and determines symbols to be statically displayed in the symbol display regions 301 to 315 corresponding to the fifteen video reels, respectively, based on the fifteen random numbers thus selected. In the present embodiment, in a case where at least five identical symbols are statically displayed in the symbol display regions 301 to 315, the CPU 106 is programmed to provide an award corresponding to the stationary symbol.

Following determination of stationary symbols, the CPU 106 determines whether at least a predetermined number (five) of identical symbols for providing an award occurs during a stationary display of the fifteen symbols. In a case where the CPU 106 determines that at least the predetermined number (five) of identical symbols are to be statically displayed, the CPU 106 activates an award flag for indicating that an award is to be provided, so that the award is provided, which corresponds to the statically displayed identical symbols of at least the predetermined number (five). The CPU 106 stores the award flag in a predetermined memory area of the RAM 110. On the other hand, in a case where less than the predetermined number (five) of identical symbols for providing an award are displayed (a losing case), the CPU 106 does not activate the award flag.

Furthermore, the CPU 106 determines whether to advance to a second game in which a portion of the symbol display area including all the symbol display regions 301 to 315 is set as an active symbol display area. An example of the second game includes a bonus game. In a case where the CPU 106 determines to switch a game to a second game, the CPU 106 activates a secondary flag for indicating that the game is to be switched to a second game. The CPU 106 stores the secondary flag in a predetermined memory area of the RAM 110. On the other hand, in a case where the CPU 106 does not determine to switch the game to a second game, the CPU 106 does not activate the secondary flag. Subsequently, the CPU 106 advances the processing to Step S6.

In Step S6, the CPU 106 transmits a signal to start dynamically displaying symbols in each of the symbol display regions 301 to 315 corresponding to the fifteen video reels respectively to the display/input controller 140. Upon the start of dynamically displaying a set of symbols in each of the fifteen video reels, the CPU 106 stands by until a predetermined period of time to elapse (Step S7). When the predetermined period of time has elapsed (“YES” in Step S7), the CPU 106 transmits a signal for statically displaying the symbols in each of the symbol display regions 301 to 315 corresponding to the fifteen video reels respectively, to the display/input controller 140. Consequently, the fifteen video reels display the predetermined stationary symbols (Step S8). Subsequently, the CPU 106 advances the processing to Step S9.

In Step S9, the CPU 106 determines whether the award flag indicating an award to be provided, which is stored in the predetermined area of the RAM 110, is activated in processing for determining stationary symbols as shown in Step S5. In a case where the award flag is not activated (“NO” in Step S9), the CPU 106 advances the processing to Step S11. On the other hand, in a case where the award flag is activated (“YES” in Step S9), the CPU 106 advances the processing to Step S10.

In Step S10, if the number of statically displayed identical symbols is equal to or greater than the predetermined number (five), the CPU 106 pays out coins according the to the number. More specifically, the CPU 106 calculates a payout amount of coins corresponding to the number of identical symbols, referring to a payout table (not shown). In a case where the statically displayed identical symbols entitled to an award matches a payout rate symbol, which provides a predetermined rate, a multiplier for the payout amount thus calculated, the CPU 106 recalculates a payout amount by multiplication using the predetermined rate corresponding to the payout rate symbol. The CPU 106 reads the credit amount stored in the RAM 110. Then, the CPU 106 adds the payout amount thus calculated (recalculated) to the credit amount thus read, and stores the resulting summation in a predetermined memory area of the RAM 110. The CPU 106 displays the stored credit amount on the credit amount display unit 49. Subsequently, the CPU 106 advances the processing to Step S11.

In Step S11, the CPU 106 determines whether the secondary flag stored in the RAM 110, which indicates that the game is to be advanced to a second game, is activated in the processing for determining stationary symbols in Step S5. More specifically, in a case where the secondary flag is activated (“YES” in Step S11), the CPU 106 advances the processing to Step S12. On the other hand, in a case where the secondary flag is not activated (“NO” in Step S11), the CPU 106 terminates the processing.

In Step S12, the CPU 106 executes second game processing. An example of the second game includes a bonus game, and the second game is performed for a predetermined number of times after the game starts. Subsequently, the CPU 106 terminates the routine.

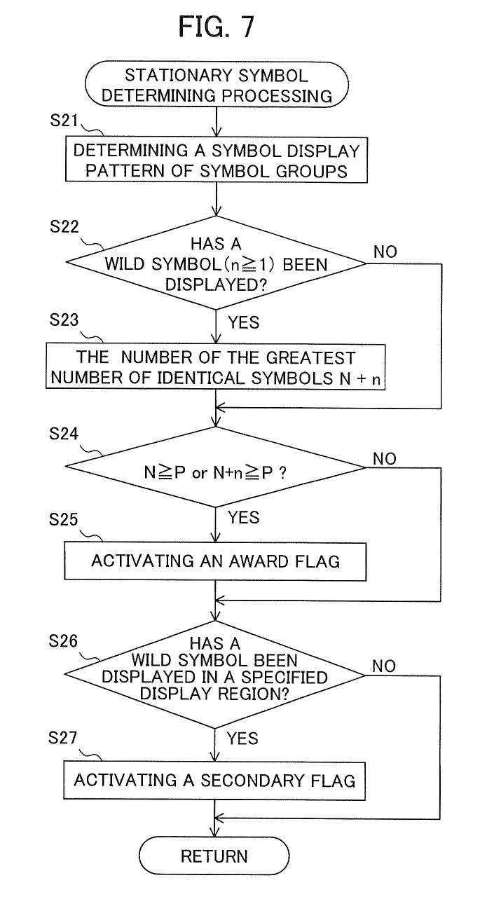

FIG. 7 is a flow chart showing one example of the processing for determining stationary symbols (S5) in FIG. 6 that shows flag activating processing with an introduction of a wild symbol. The flow chart in FIG. 7 is one of the important routines performed by the controller, which implement the following processing, according to the embodiment of the present invention: (a) performing a first game in which an award is determined based on the number of identical symbols statically displayed within the symbol display area including all of the symbol display regions, and (b) in a case where a symbol statically displayed in a specified symbol display region within the symbol display area matches a wild symbol substitutable for any kind of symbol, performing a second game in which the symbol display regions surrounding the wild symbol as a center and immediately adjacent to the wild symbol are set as an active symbol display area, and an award is determined based on a number of identical symbols statically displayed for each game in which a plurality of kinds of symbols are dynamically and statically displayed in the active symbol display area.

FIG. 10 is a diagram showing a stationary symbol probability table for identical symbols and FIG. 11 is a diagram showing a stationary symbol probability table for a wild symbol. FIG. 7 is described referring to FIGS. 10 and 11.

As shown in the processing of Step S21, selecting fifteen random numbers, the CPU 106 determines a symbol to be statically displayed from a set of symbols for each of the symbol displaying regions 301 to 315 corresponding to the fifteen video reels respectively based on the selected fifteen random numbers.

The processing for statically displaying identical symbols in Step S21 is controlled as follows, for example: The CPU 106 determines the number of identical symbols to be displayed based on a stationary symbol probability table for identical symbols, such as shown in FIG. 10. In this connection, different display probabilities are allocated to respective symbols such that the order of priority is implemented for the probability of a symbol to be selected.

Displaying of the wild symbol in the processing in Step S21 is controlled as follows, for example: Referring to a stationary symbol probability table for a wild symbol such as shown in FIG. 11, the CPU 106 causes a wild symbol to replace one of the symbols displayed in the symbol display regions 301 to 315. Referring to FIG. 11, in a case where a wild symbol is included in the statically displayed symbols and the wild symbol is displayed at a display position other than a specified display position, the CPU 106 selects one of the numbers from one to three, and replaces arbitrary symbols arranged at display positions other than the specified display position with wild symbols according to the selected number. In a case where the CPU 106 determines that a wild symbol is to be displayed at a first specified display position, the CPU 106 permits a display of one wild symbol that replaces a symbol arranged at the first specified display position. Furthermore, in a case where the CPU 106 determines that a wild symbol is to be displayed at a second specified display position, the CPU 106 permits a display of one wild symbol that replaces a symbol arranged at the second specified display position. Moreover, in a case where the CPU 106 determines that two wild symbols are to be displayed at the first and the second specified display positions, the CPU 106 permits a display of the two wild symbols that replace symbols arranged at the first and the second specified positions, respectively. In addition, the term “specified display position” used here indicates a display position which triggers setting an active symbol display area for a second game. For example, a symbol display region 305 positioned at the center of a second column and a symbol display region 311 positioned at the center of a fourth column are set as specified display positions. For convenience sake, the symbol display region 305 is called the first specified display position and the symbol display region 311 the second specified display position.

In the following Step S22, the CPU 106 determines whether a wild symbol is selected to be statically displayed in any one of the symbol display regions 301 to 315. In a case where such a wild symbol has been selected, the CPU 106 advances the processing to Step S23. In Step S23, the CPU 106 adds the number “n” of the wild symbols to the greatest number N of symbols of the same kind. If two or more groups of symbols of the same kind have a common greatest number N, the CPU 106 performs the processing in step S23 for the group of the symbols possessing higher priority, for example. Furthermore, in a case where there are no groups of identical symbols at all among statically displayed symbols, the CPU 106 performs the processing in step S23 for a number N (one) of identical symbol, which has higher priority, for example. Subsequently, the CPU 106 advances the processing to Step S24. On the other hand, in Step S22, in a case where the wild symbol to be statically displayed has not been selected, the CPU 106 advances the processing to Step S24.

In Step S24, the CPU 106 compares a predetermined number P with the number N of identical symbols or the number (N+n), a summation of the number of identical symbols and the number of the wild symbols. The number P is a predetermined number (five) that enables a player to receive an award, as described above. In a case where the number of identical symbols N or (N+n) is equal to or greater than the predetermined number P (five), the CPU 106 activates an award flag in Step S25 indicating that an award is to be provided, and advances the processing to Step S26. The award flag is stored in the predetermined memory area of the RAM 110 by the CPU 106 as described above. The award flag may include a plurality of bits so as to distinguish one award from another in terms of an amount of award, for example. On the other hand, in a case where the number of identical symbols N or (N+n) is less than the predetermined number P (five), the award flag is not activated, and the CPU 106 advances the processing to Step S26.

In Step S26, the CPU 106 determines whether a wild symbol, which is included in statically displayed symbols, is positioned at a specified display position. Two positions as an example, the symbol display region 305 positioned at the center of the second column and the symbol display region 311 positioned at the center of the fourth column among all the symbol display regions 301 to 315, are set as the specified display positions, as described above. Thus, in a case where the stationary symbol displayed in either the symbol display region 305 or 311 matches a wild symbol, the CPU 106 activates a secondary flag in Step S27 indicating that the game is to be advanced to a second game, and terminates the routine. The secondary flag is stored in the predetermined area of the RAM 110 by the CPU 106 as described above. The flag may include a plurality of bits to distinguish setting modes of active symbol display area, for example. On the other hand, in a case where the stationary symbols displayed in both the symbol display regions 305 and 311 are different than a wild symbol, the CPU 106 does not activate the secondary flag and terminates the routine.

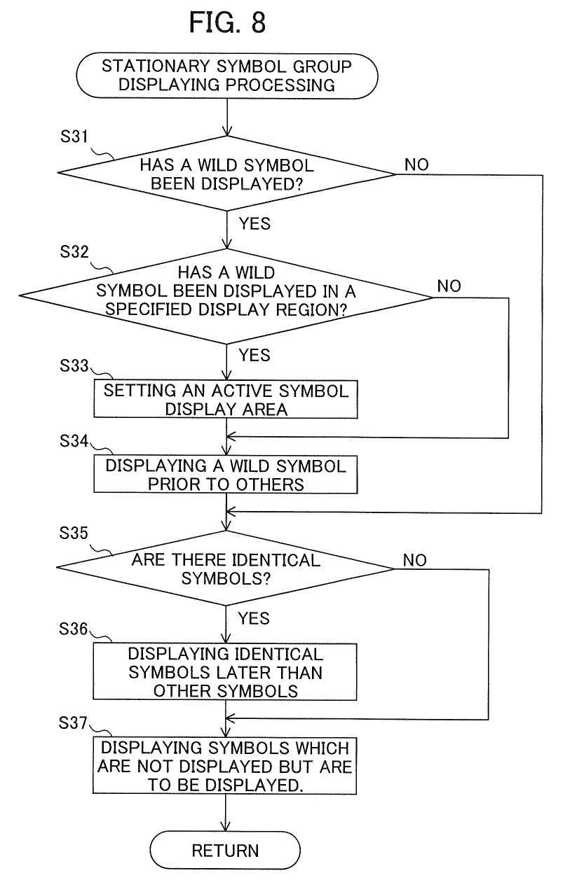

FIG. 8 is a flow chart showing an example of processing for displaying stationary symbols and an order to display symbols with consideration of rendered images in relation to a wild symbol. The flow chart in FIG. 8 is one of the important routines performed by the controller, which implement the following processing, according to the embodiment of the present invention: (a) performing a first game in which an award is determined based on a number of identical symbols statically displayed within the symbol display area including all the symbol display regions, and (b) in a case where a symbol that is statically displayed in a specified symbol display region prior to other symbols to be displayed in any other symbol display region during the first game matches a wild symbol substitutable for any kind of symbol, performing a second game in which symbol display regions surrounding the wild symbol as a center and immediately adjacent to the wild symbol are set as an active symbol display area, and an award is determined based on a number of identical symbols statically displayed for each game in which a plurality of kinds of symbols are dynamically and statically displayed in the active symbol display area.

As shown in the processing of Step S31, the CPU 106 determines whether there is a wild symbol among stationary symbols displayed in the symbol display regions 301 to 315, which are determined according to the processing shown in FIG. 7, for example. In a case where there is a wild symbol among the stationary symbols, the CPU 106 advances the processing to Step S32. On the other hand, in a case where there is not a wild symbol among the stationary symbols, the CPU 106 moves the processing to Step S35.

In Step S32, the CPU 106 determines whether the wild symbol that is determined in FIG. 7, for example, is positioned at a specified display position. In other words, in a case where the stationary symbol to be displayed in either the symbol display region 305 or 311 has been determined to be a wild symbol, the CPU 106 advances the processing to Step S33. On the other hand, in a case where the stationary symbols to be displayed in the symbol display regions 305 and 311 are different than a wild symbol, the CPU 106 advances the processing to Step S34.

In Step S33, the CPU 106 transmits an image display instruction for setting an active symbol display area to display/input controller 140 (refer to FIGS. 4 to 5). In Step S34, the CPU 106 transmits an image display instruction for displaying a wild symbol to the display/input controller 140 (refer to FIGS. 4 and 5), and displays the wild symbol prior to the other symbols to be displayed in all of the symbol display regions 301 to 315.

In Step S35, the CPU 106 determines whether there are identical symbols among stationary symbols displayed in the symbol display regions 301 to 315, which are determined in the processing for determining stationary symbols as shown in FIG. 7, for example. In a case where there are identical symbols among the stationary symbols, the CPU 106 advances the processing to Step S36. In a case where there are no identical symbols among the stationary symbols, the CPU 106 advances the processing to Step S37.

In Step S36, the CPU 106 transmits an image display instruction for displaying identical symbols later than symbols other than the identical symbols to display/input controller (refer to FIGS. 4 to 5). In a case where there is a plurality of groups of identical symbols, the CPU 106 displays symbols referring to the order of priority determined in advance, for example.

In Step S37, the CPU 106 statically displays symbols in symbol display regions in which a symbol has not been displayed. In other words, in a case where a wild symbol is arranged, the CPU 106 statically displays symbols in the symbol display regions other than the symbol display region in which the wild symbol is arranged. Here, the CPU 106 displays a group of identical symbols at a later time. Furthermore, in a case where the setting of an active symbol display area in the processing in Step S33 is controlled so as to be performed during the first game processing, the symbol display regions to be displayed in Step S37 coincide with the active symbol display area. In a case where the setting of an active symbol display area in the processing in Step S33 is controlled so as to be performed during the second game processing, the symbol display regions to be displayed in Step S37 are the symbol display area including all of the symbol display regions 301 to 315. The CPU 106 statically displays predetermined symbols in the symbol display regions in accordance with a flow of processing described above, and terminates the routine.

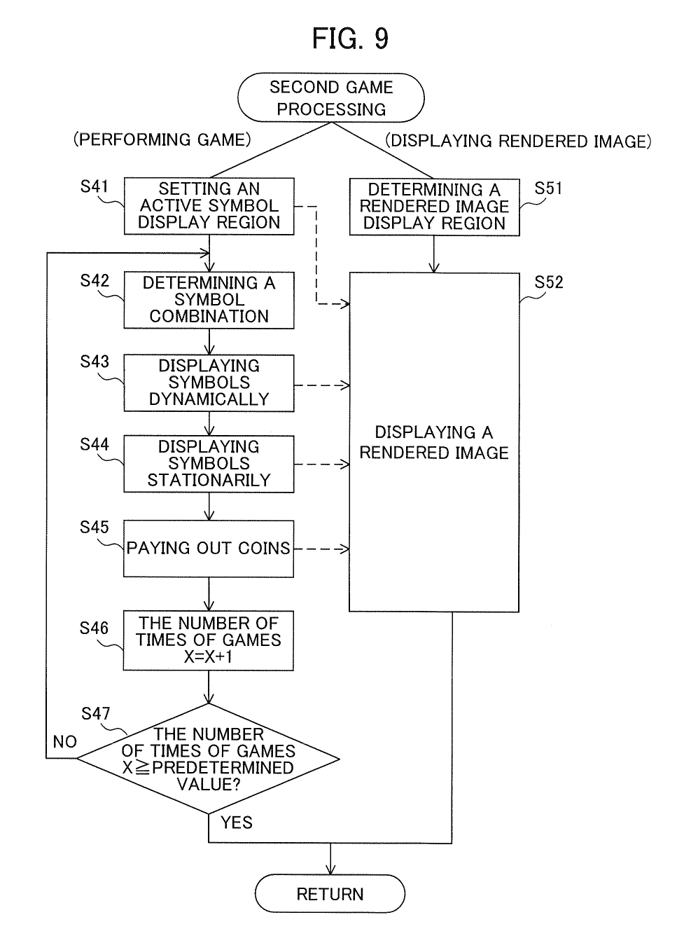

FIG. 9 is a flow chart showing an example of a second game processing in FIG. 6, in a case of performing a bonus game as a second game. The flow chart in FIG. 9 is related to a slot machine that performs a basic game as a first game and a bonus game as a second game, and shows that the bonus game is performed in an active symbol display area (gaming area), occupying a portion of the symbol display regions (301 to 315), and a rendered image is displayed on the symbol display regions that lie outside the active symbol display area (area of rendered effects). The bonus game includes a plurality of free games.

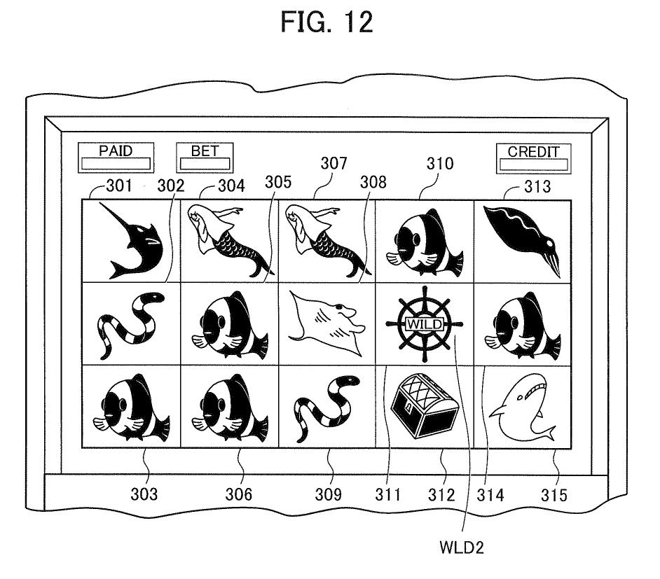

FIGS. 12 to 19 shows examples of a display screen for games performed by the gaming machine according to the embodiment of the present invention. FIGS. 12 to 19 in addition to the figures described heretofore are referred to in the following description.

In FIG. 9, in Step S41, upon the display/input controller 140 (refer to FIGS. 4 and 5) receiving an image display instruction for setting an active symbol display area from the CPU 106, the CPU 146 reads a display control program stored in the ROM 148 and determines an active symbol display area. For example, as shown in FIG. 12, during a first game, in a case where a wild symbol WLD2 is statically displayed in the symbol display region 311 which is one of the display positions that trigger setting an active symbol display area for a second game, the CPU 146 determines symbol display regions 307 to 315 as an active symbol display area (ASA2). Subsequently, the CPU 146 transmits a signal instructing a start of the second game to the CPU 106. Then, the CPU 146 advances the processing to Step S42.

In parallel with the processing in step S41 where the active symbol display area including symbol display regions 307 to 315 is determined, the CPU 146 determines that the symbol display regions 301 to 306 are to be used as an area for displaying a rendered image, as shown in Step S51. Subsequently, the CPU 146 displays the rendered image related to a second game (a bonus game) in the symbol display regions 301 to 306 (S52).

In Step S42, the CPU 106 advances the processing to the second game program area, and determines a combination of symbols. Since the second game is performed as a bonus game, the second game is programmed so as to provide a display including a combination of symbols. For example, one combination of symbols is selected from combinations of symbols along active lines including vertical, horizontal and diagonal lines having a wild symbol positioned at the symbol display region 311 as a center of the active lines. The wild symbol WLD2 is fixed as a stationary symbol during the second game. Subsequent to the processing in S42, the CPU 106 moves the processing to Step S43.

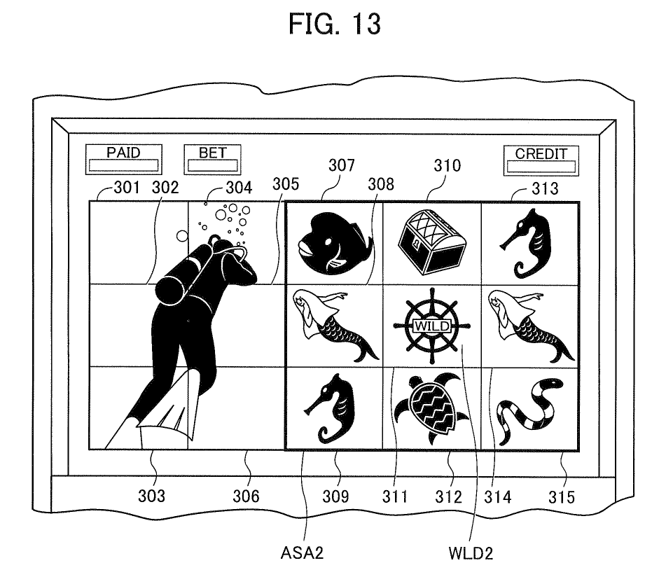

In Step S43, the CPU 106 transmits a signal to the display/input controller 140 to start dynamically displaying symbols on eight video reels in the symbol display regions 307 to 310 and 312 to 315, which are positioned adjacent to the wild symbol WLD2. Subsequently, the symbol display regions 307 to 310 and 312 to 315 within the active symbol display area (ASA2) start to dynamically display a set of symbols on each of the eight video reels. After a predetermined period of time has elapsed, the CPU 106 transmits a signal to the display/input controller 140 for displaying a stationary symbol in each of the symbol display regions 307 to 315 and 312 to 315 within the active symbol display area ASA2. Subsequently, the predetermined symbols of the eight video reels are statically displayed (Step S44). More specifically, as shown in FIG. 13, a set of symbols is dynamically displayed in each of the symbol display regions 307 to 310 and 312 to 315 within the active symbol display area ASA2, followed by a symbol of the set of symbols being statically displayed, for example. In FIG. 13, symbols displayed in the symbol display regions 309, 311 and 313 form an active line, and symbols displayed in the symbol display regions 308, 311 and 314 form another one, also. In addition, a rendered image and the like including a diver is displayed on the rendered image display area including symbol display regions 301 to 306, in association with the marine symbols displayed in the active symbol display area ASA2. The remaining number of games may be displayed in the rendered image as information. Subsequent to the processing in Step S44, the CPU 106 advances the processing to Step S45.

In Step S45, the CPU 106 pays out an amount of coins corresponding to the number of identical symbols. Preferably, in this situation, the CPU 106 pays out an amount of coins corresponding to the active line. More specifically, the CPU 106 refers to a payout table for a second game (a bonus game) (not shown), calculates a payout amount, and displays the payout amount on the credit amount display unit 49 (refer to FIG. 3). Subsequently, the CPU 106 advances the processing to Step S46, and adds one to the number of games X. It should be noted that the number of games X is initialized at the termination of a second game, so that at the beginning of a second game, the number of games X has an initialized value X=0. Subsequent to the processing of Step S46, the CPU 106 advances the processing to Step S47.

In Step S47, the CPU 106 determines whether the number of games X is equal to or greater than a predetermined number which limits the number of games. In a case where the number of games X is less than the predetermined number, the CPU 106 advances the processing to Step S42 to restart another second game (bonus game). When the number of games X has reached the predetermined number, the CPU 106 concludes the routine to terminate the second game (bonus game).

In FIG. 9, broken arrow directed to rendered image processing S52 from processing of Steps S41, S42, S43, S44 and S45 indicate that a rendered image may be conjunctionally changed, in such a manner that a display of the rendered image is switched according to timing of each processing.

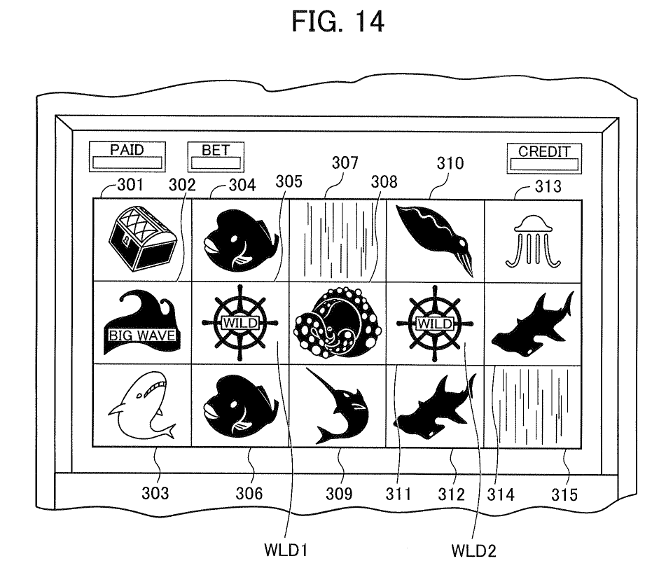

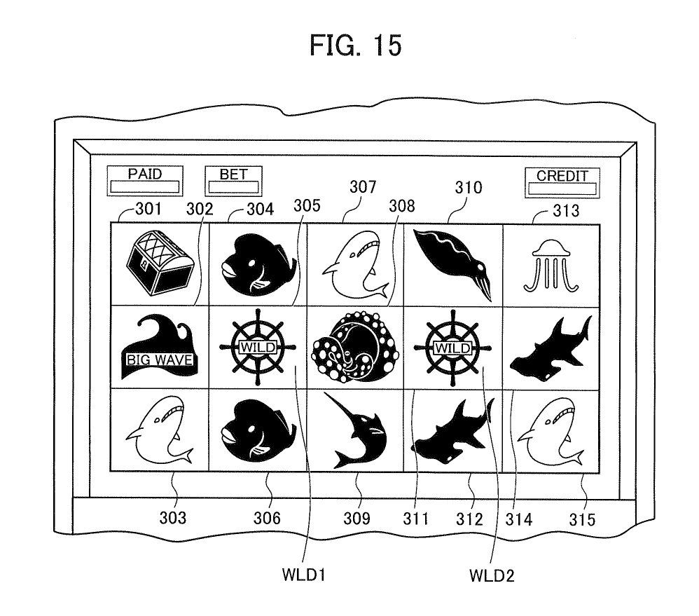

FIGS. 14 and 15 show display screens related to arbitrary symbols including symbols of the same kind displayed dynamically and statically, and the processing of Step S36 described in the abovementioned FIG. 8. In other words, identical symbols are displayed later than other symbols. Descriptions of FIGS. 14 and 15 are given below along with a description of the processing flow of FIG. 8.

Firstly, while a set of symbols is being dynamically displayed in each of the symbol display regions 301 to 315, the prioritized wild symbols WLD1 and WLD2 are statically displayed. Subsequently, a single symbol which does not form a group of symbols of the same kind is statically displayed. In other words, each of the symbols in the symbol display regions 301, 302, 308, 309, 310, and 313 is displayed statically subsequent to the wild symbols WLD1 and WLD2. Subsequently, symbols forming a group of identical symbols are statically displayed. In other words, each of the symbols in the symbol display regions 304, 306, 312, 314, 303, 307, and 315 is displayed statically, subsequent to the symbols which do not form a group of identical symbols. Referring to FIGS. 14 and 15, the game is operated in such a manner that each of the symbols in the symbol display regions 303, 307 and 315 is displayed last among the symbols forming a group of identical symbols, however, it is not limited thereto as long as the symbols forming a group of identical symbols are statically displayed later than the other symbols.

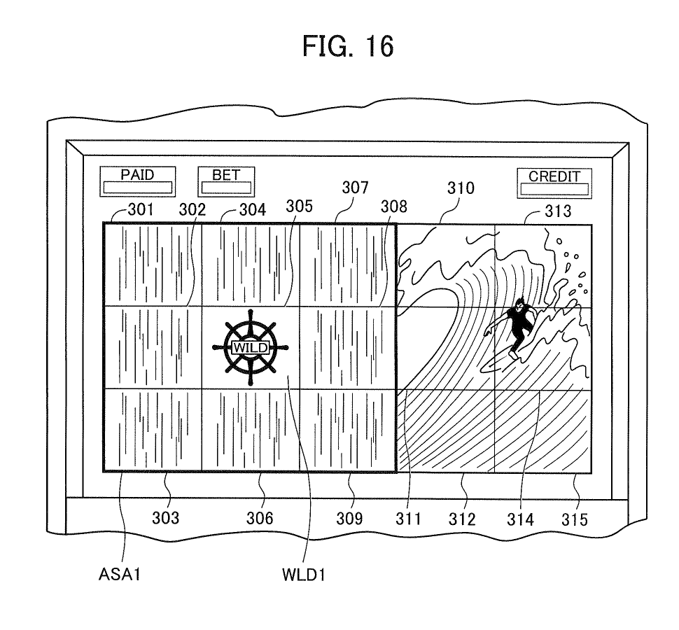

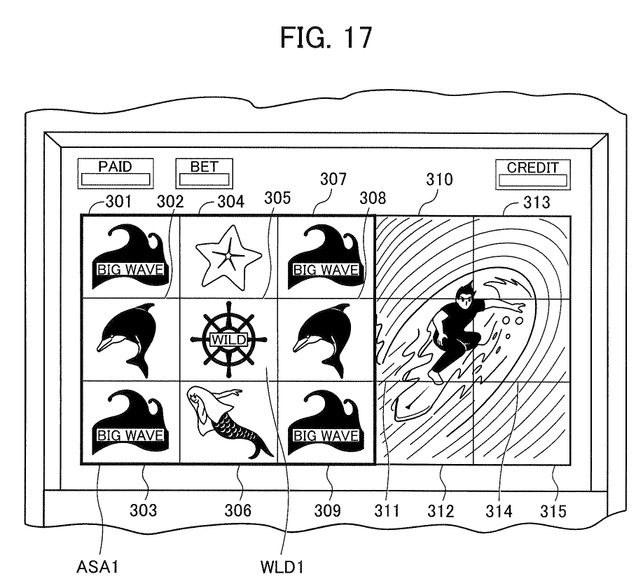

Furthermore, referring to FIGS. 14 and 15, two wild symbols WLD1 and WLD2 are arranged at specified display positions. In this case, the second game is performed in such a manner that the active symbol display areas ASA1 and ASA2 are selected alternately, which include the wild symbols WLD1 and WLD2 as centers, respectively, whereby the object of the present invention is achieved. More specifically, two exemplary displays depicted in FIGS. 1 and 13 are alternately changed, so that a reduced display area of the second game compared to that of the first game is implemented. FIGS. 16 and 17 show examples of display screens depicting a switch to a second game, which is performed through the execution of processing as shown in step S33 of FIG. 8, for example. Such switching is performed at a time when a wild symbol displayed earlier than other symbols has been displayed in a specific display position that triggers setting of an active symbol display area. In other words, in the processing of Step S33, the CPU 106 may output an instructional signal to the program for executing the second game processing of FIG. 9 and executes the processing of Step S41.

For example, during a first game as a basic game, as shown in FIG. 16, in a case where the statically displayed wild symbol WLD1 corresponds to the symbol display region 305 which is one of the specified display positions, the active symbol display area ASA1 is presented. Furthermore, the symbol display regions 310 to 315, which lie outside the active symbol display area ASA1, are presented as a rendered image display area. This helps a player recognize that the game is advanced to the second game (a bonus game). Subsequently, as shown in FIG. 17, symbols dynamically displayed within the active symbol display area ASA1 come to rest. Accordingly, as the rendered image displayed on the symbol display regions 310 to 315, a sequence of actions such as a surfing scene, for example, is displayed. For example, in the last round of the second game (a bonus game), as shown in the active symbol display area ASA1 in FIG. 17, a big bonus of achieving at least three vertical, horizontal and diagonal active lines is awarded with a display of the rendered image, allowing a player to feel fully excited.

It may be limited to a first round of the second game or arbitrarily determined during second and subsequent rounds that the wild symbol WLD1 is statically displayed at the specified position. Such a configuration allows a player to comprehend the rarity value of a wild symbol.

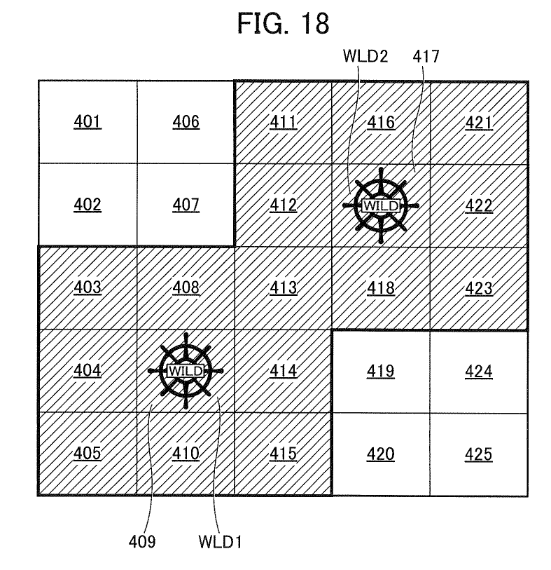

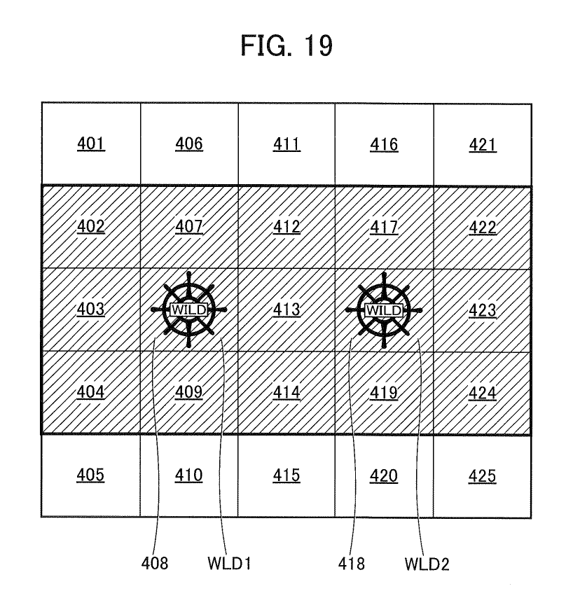

FIGS. 18 and 19 each show an example of a display screen for a case where two wild symbols are statically displayed in the specified display positions that trigger setting an active symbol display area, which are other embodiments according to the present invention.

As shown in FIG. 18, among all display regions 401 to 425 of a first game, a wild symbol WLD1 is statically displayed in a symbol display region 409 and a wild symbol WLD2 is statically displayed in a symbol display region 417. Accordingly, an area including all symbol display regions immediately adjacent to the wild symbol WLD1 and WLD2, that is, shaded symbol display regions 403 to 405, 408 to 418 and 421 to 423, is set as an active symbol display area. With such a configuration, it is possible to provide a gaming machine that can advance to a special game, a second game, performed with a reduced display area compared to that of the first game.

As shown in FIG. 19, among all the display regions 401 to 425 of the first game, the wild symbol WLD1 is statically displayed in the symbol display region 408 and the wild symbol WLD2 is statically displayed in the symbol display region 418. Accordingly, an area including all symbol display regions immediately adjacent to the wild symbol WLD1 and WLD2, that is, shaded symbol display regions 402 to 404, 407 to 409, 412 to 414,417 to 419 and 422 to 424, is set as an active symbol display area.

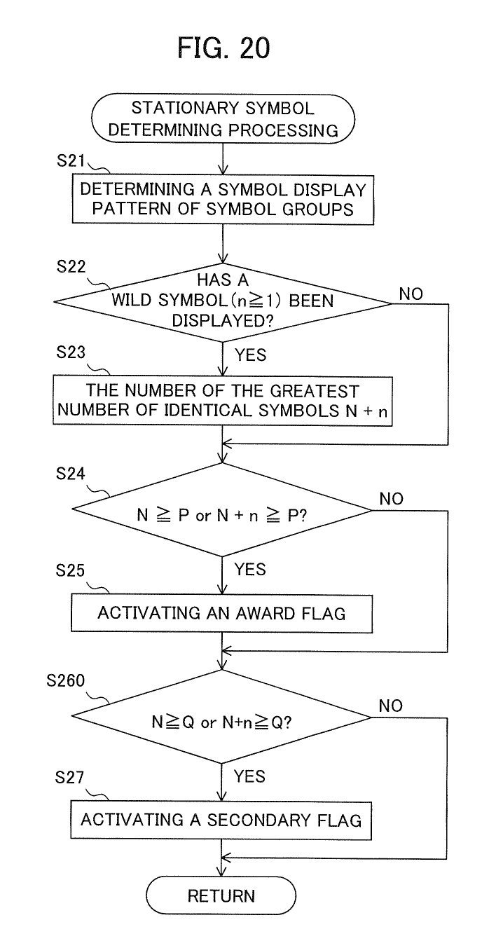

FIG. 20 relates to another embodiment according to the present invention and is a flow chart showing a flow of processing, which may be substituted for the flow chart of FIG. 7. The flow chart in FIG. 20 is intended for a case where a statically displayed wild symbol and a setting of an active symbol display area are not related to each other or a wild symbol is not adopted at least in a first game (a basic game). The flow chart in FIG. 20 includes Step S260 as a substitute for Step S26 in FIG. 7. Since other steps included in the flow chart are the same as the steps in FIG. 7, descriptions for the same steps are omitted. In FIG. 20, a wild symbol is not statically positioned at a specified display position that triggers setting an active symbol display area. Instead, the processing in Step S260 determines whether to set an active symbol display area according to a predetermined condition. Symbol Q in Step S260 indicates a predetermined number of identical symbols. For an example, Q is set to be equal to six (Q=6). In a case where the greatest number of identical symbols among symbols displayed in the symbol display regions 301 to 315, is equal to or greater than six, a secondary flag is activated. Accordingly, the game may be advanced to a second game (a bonus game). In addition, in a case where the number “n” of statically displayed wild symbols exists among the symbol display regions 301 to 315, the game can be advanced to a second game (a bonus game) on condition that the greatest number N+n of the identical symbols is equal to or greater than six. In other words, in a case where the predetermined or greater number of symbols for advancing to the second game is statically displayed in the symbol display regions 301 to 315 used in the first game, the game can be advanced to the second game.

While the embodiments of the gaming machine according to the present invention have been described, it is to be understood that the above description is intended to be illustrative, and not restrictive, and any changes in design may be made to specific configurations such as various means. Moreover, it should be understood that the advantages described in association with the embodiments are merely a listing of most preferred advantages, and that the advantages of the present invention are by no means restricted to those described in connection with the embodiments.

For example, in the present embodiment, although a description is given for a case in which a group of symbols that matches a combination of symbols along an active line in a second game (a bonus game) is entitled to an award, a combination of symbols according to the number of identical symbols may alternatively be entitled to an award.

What is claimed is:

1. A gaming machine, comprising:
a display, having a symbol display area divided into a plurality of symbol display regions, for displaying a plurality of kinds of symbols to be dynamically and statically displayed in each of the symbol display regions for each game;
an input device for starting a game in which a predetermined award is provided based on a number of identical symbols statically displayed in the plurality of symbol display regions within the symbol display area; and
a controller configured to execute the processing comprising:
(a) performing a first game in which an award is determined based on a number of identical symbols statically displayed within the symbol display area including all the symbol display regions; and
(b) performing a second game in which a portion of the symbol display area is set as an active symbol display area, and an award is determined based on a number of identical symbols statically displayed for each unit game in which a plurality of kinds of symbols are dynamically and statically displayed in the active symbol display area.

2. The gaming machine according to claim 1, wherein the first game is a basic game and the second game is a bonus game.

3. The gaming machine according to claim 2, wherein the bonus game includes a plurality of free games.

4. The gaming machine according to claim 1, wherein in a case where at least a predetermined number of symbols for triggering a start of the second game is statically displayed within the symbol display area including all the symbol display regions used in the first game, the controller is configured to cause the first game to be switched to the second game.

5. A gaming machine, comprising:
a display, having a symbol display area divided into a plurality of symbol display regions, for displaying a plurality of kinds of symbols to be dynamically and statically displayed in each of the symbol display regions for each game;
an input device for starting a game in which a predetermined award is provided based on a number of identical symbols statically displayed in the plurality of symbol display regions within the symbol display area; and
a controller configured to execute the processing comprising:
(a) performing a first game in which an award is determined based on a number of identical symbols statically displayed within the symbol display area including all the symbol display regions; and
(b) in a case where a symbol statically displayed in a specified symbol display region within the symbol display area matches a wild symbol substitutable for any kind of symbol, performing a second game in which symbol display regions surrounding the wild symbol as a center and immediately adjacent to the wild symbol are set as an active symbol display area, and an award is determined based on a number of identical symbols statically displayed for each game in which a plurality of kinds of symbols is dynamically and statically displayed in the active symbol display area.

6. The gaming machine according to claim 5, wherein in the processing of (b), the controller is configured to cause the wild symbol to be fixed as a stationary symbol at the center of the active symbol display area during at least one round of the second game from the beginning thereof.

7. The gaming machine according to claim 5, wherein in the processing of (b), in a case where the wild symbol is statically displayed in each of a plurality of specified symbol display regions, the controller is configured to cause a total area including symbol display regions immediately adjacent to each of the plurality of specified symbol display regions to be set as an active symbol display area.

8. A gaming machine, comprising:
a display, having a symbol display area divided into a plurality of symbol display regions, for displaying a plurality of kinds of symbols to be dynamically and statically displayed in each of the symbol display regions for each game;
an input device for starting a game in which a predetermined award is provided based on a number of identical symbols statically displayed in the plurality of symbol display regions within the symbol display area; and
a controller configured to execute the processing comprising:
(a) performing a first game in which an award is determined based on a number of identical symbols statically displayed within the symbol display area including all the symbol display regions; and
(b) in a case where a symbol that is statically displayed in a specified symbol display region prior to other symbols to be displayed in any other symbol display region during the first game matches a wild symbol substitutable for any kind of symbol, performing a second game in which symbol display regions surrounding the wild symbol as a center and immediately adjacent to the wild symbol are set as an active symbol display area, and an award is determined based on a number of identical symbols statically displayed for each game in which a plurality of kinds of symbols is dynamically and statically displayed in the active symbol display area.

9. The gaming machine according to claim 8, wherein in the processing of (b), the controller is configured to cause the wild symbol to be statically displayed at the center of the active symbol display area during one of only a first round of the second game and second and subsequent rounds of the second game.

10. The gaming machine according to claim 8, wherein in the processing of (b), in a case where the wild symbol is statically displayed in each of a plurality of specified symbol display regions, the controller is configured to cause a total area including symbol display regions immediately adjacent to each of the plurality of specified symbol display regions to be set as an active symbol display area.
